(19) United States
(12) Patent Application Publication
(10) Pub. No.: US 2009/0076658 A1
(43) Pub. Date: Mar. 19, 2009

(54) BUILDING CLIMATE CONTROL SYSTEM AND METHOD

(76) Inventor: Ralph Kinnis, Delta (CA)

Correspondence Address: KLARQUIST SPARKMAN, LLP, 121 SW SALMON STREET, SUITE 1600, PORTLAND, OR, 97204, US

(21) Appl. No.: 12/196,204

(22) Filed: Aug. 21, 2008

Related U.S. Application Data
(60) Provisional application No. 60/935,593, filed on Aug. 21, 2007.

(51) Int. Cl. G05B 15/00; F24F 7/007; G05D 23/00

(52) U.S. Cl. 700/277; 236/49.3; 236/46 R

(57) ABSTRACT

The climate in a primary space within a building having a secondary space open to and above the primary space is controlled by creating a primary microclimate within the primary space that is resistant to convection phenomena in the primary and secondary spaces. When the temperature in the secondary space is higher than the temperature in the primary space, air is drawn from the secondary space and discharged into the primary space at an initial air exchange rate which causes the temperature in the primary space to rise and the temperature in the secondary space to fall. When the temperature in the primary space is greater than or equal to the temperature in the secondary space, the air exchange rate is set at a primary microclimate maintenance rate such that the temperature in the primary space remains equal to or greater than the temperature in the secondary space, thereby establishing the primary microclimate in the primary space.

### CROSS REFERENCE TO RELATED APPLICATIONS

This application claims the benefit of U.S. Provisional Application No. 60/935,593, filed on Aug. 21, 2007, which is incorporated herein by reference.

### FIELD

This invention relates generally to a method for controlling the climate in a building, and an apparatus for carrying out the method.

### BACKGROUND

Buildings such as single and multiple occupancy residences, commercial offices, industrial buildings and commercial greenhouses require heating and/or cooling to provide a comfortable environment for occupants of the buildings or to meet the commercial or industrial purposes of the building.

Conventional heating, ventilation and air conditioning (HVAC) equipment installed in buildings typically heat or cool an interior space by heating or cooling air and discharging the conditioned air into the interior space. When in a heating routine, the HVAC equipment continues to heat the air and discharge the heated air into the space until a thermostat in the space detects that the air temperature in the space has reached a temperature setpoint. Similarly, in a cooling routine, the HVAC equipment will extract heat from air and discharge cooled air into the space until the thermostat in the space detects that the air temperature has lowered to the temperature set point.

Convection phenomenon result in inefficiencies in heating and cooling by conventional HVAC equipment. Heated air will tend to rise above the occupied space in the building such that the upper part of the space can be at the temperature set point but the occupied space still remain below the temperature set point, thus additional heat will have to be injected into the space until the occupied portion of the space is at the desired temperature. The reason this occurs is due to the natural convective nature present within the air and within the space; the lightest and warmest air rises to the top of the space, while the heavier and cooler air drops down, with the coolest air been present at floor level. The heat contained within the warm air at the top of the building will transfer heat to the surface of the ceiling material and accordingly conduct through the top of the building and thus be wasted, and the resulting cool air at the ceiling of the structure, which was created due to the loss of heat from the air to the ceiling drops down and is then replaced by warm air from below it. The natural convective force within the space continues due to temperature differentials between the inside of the space and the outside of the space in direct relation to the actual temperature differential and the R value (insulation factor) of the materials separating the inside of the structure from the outside environment. Therefore, the HVAC equipment must continue to supply heated air into the space until the temperature at the level of the temperature control within the occupied space reaches the required set point. Since the space near the ceiling is typically not occupied and is heated due to the natural convective forces, the heated air in this space results in wasted energy and cost. In other words, conventional HVAC equipment ends up heating the entire space, even though only a portion of the space is occupied and requires heat.

Convection phenomenon also present a challenge to cooling a space, as cooled air which is typically blown upwards or into the upper part of a room will quickly fall to floor level. The temperature at floor level may be at the temperature set point, while the rest of the occupied space remains above the temperature set point. Further, hotter air rises towards and becomes trapped at the ceiling of the room, which heats up and creates severe stratification factors such that in order to keep the occupied part of the room at the temperature setpoint, cooled air must continue to be discharged into the room. In other words, conventional HVAC equipment must discharge cooled air to not just cool the occupied space but also to overcome the heat stratification factors associated with heated air trapped at the top of the room.

It is known that the overall HVAC energy load of a building can be reduced by controlling the heating or cooling of individual rooms in the building. Individual thermostats are provided in each room, and HVAC systems exist which individually control the climate in each of these rooms. Therefore, rooms which are not used can be controlled at a much lower set point to save on energy usage. While such multiple zone control does provide improved HVAC energy usage, the problems associated with convection phenomenon in heating and cooling each individual room still exist.

Efforts have been made to control the temperature within a single room, by physically partitioning the room into multiple spaces wherein heating and cooling efforts are directed to the certain spaces only. An example of such physical partitioning is disclosed in WO 96/26395 (Tiansen). While such physical partitioning may serve to reduce the overall HVAC energy usage for the room, such partitions are unsightly and can interfere with the use of the room.

### SUMMARY

In some embodiments, it is an object of the invention to provide a solution to at least some of the problems associated with the prior art. One particular objective is to provide means and method for heating and cooling an interior space of an enclosure in an energy efficient and effective manner.

According to one aspect, there is provided a method and apparatus for controlling the climate in a primary space within a building having a secondary space open to and above the primary space. The method comprises drawing air from the secondary space at around the intersection of the secondary space and primary space and discharging the drawn air into the primary space at around the bottom thereof, at a rate selected to cause the temperature in the primary space to rise and the temperature in the secondary space to fall when the temperature in the secondary space is higher than the temperature in the primary space; and circulating air within the primary space at a primary microclimate maintenance rate selected to cause the temperature in the primary space to stabilize at or above the temperature in the secondary space, thereby establishing a primary microclimate in the primary space that is resistant to convection phenomena in the primary and secondary spaces.

The primary microclimate maintenance rate can be selected by drawing air from the secondary space and discharging the drawn air into the primary space at an initial rate and incrementally increasing this rate until the temperature in the primary space rises and the temperature in the secondary space falls, and the temperature in the primary space stabilizes at or above the temperature in the secondary space.

During a period of solar gain when the temperature of the secondary space has risen above the temperature in the established primary microclimate and when the primary microclimate requires heating, the air exchange rate can be reduced such that the primary microclimate is disrupted and air heated by solar gain is drawn from the secondary space and discharged into the primary space. When the temperature of the primary space has risen to within a target temperature range or after an elapsed period of time, the air exchange rate can be increased back to the primary microclimate maintenance rate thereby re-establishing the primary microclimate within the primary space.

When after the elapsed period of time after the primary microclimate has been disrupted the temperature in the primary space has not risen to the target temperature range, heat can be directed from a heating source into the primary space to heat the primary space. Also, the air exchange rate can be increased to the primary microclimate maintenance rate to re-establish the primary microclimate within the primary space.

When the temperature of the primary microclimate is below a low temperature threshold, an “aggressive heating strategy” can be applied wherein heat can be directed from a heating source into the primary space until the temperature in the primary microclimate has risen above the low temperature threshold.

When the temperature outside of the building is cooler than the temperature in the secondary space, and the primary microclimate requires cooling, cool outside air can be drawn into the secondary space and warm air can be discharged from the secondary space to outside the building.

When the outside air is cooler than the air in the primary microclimate and the primary microclimate requires cooling, the air exchange rate can be reduced such that the primary microclimate is disrupted and cool outside air falls from the secondary space into the primary space. When the temperature of the primary space has fallen to within a target temperature range or after an elapsed period of time, the air exchange rate can be increased to the primary microclimate maintenance rate to re-establish the primary microclimate within the primary space.

After the elapsed period of time after the primary microclimate has been disrupted and the temperature in the primary space has not fallen to the target temperature range, cooled air from a cooling source can be directed into the primary space to cool the primary space. Also, the air exchange rate can be increased to the primary microclimate maintenance rate thereby re-establishing the primary microclimate within the primary space.

According to another aspect, there is provided an apparatus for controlling the climate in a primary space of a building having a secondary space above and open to the primary space. This apparatus comprises:
(a) an air circulation unit having a unit fan and an airflow conduit in airflow communication with the fan, and having a return air end in airflow communication with the secondary space at around the intersection of the primary and secondary spaces and a supply air end in airflow communication with the primary space at around the bottom thereof;
(b) a primary microclimate temperature sensor in the primary space;
(c) a secondary microclimate temperature sensor in the secondary space; and
(d) a controller communicative with the air circulation unit and the primary and secondary microclimate temperature sensors and having a memory encoded with steps and instructions for execution by the controller to carry out a method comprising:
   when the temperature measured by the secondary microclimate temperature sensor is higher than the temperature measured by the primary microclimate temperature sensor, operating the fan to draw air from the secondary space and discharging the drawn air into the primary space at a rate selected to cause the temperature in the primary space to rise and the temperature in the secondary space to fall; and
   operating the fan to circulate air within the primary space at a primary microclimate maintenance rate selected to cause the temperature in the primary space to stabilize at or above the temperature in the secondary space, thereby establishing a primary microclimate in the primary space that is resistant to convection phenomena in the primary and secondary spaces.

The apparatus further can include a return air duct communicative with the return air end of the airflow conduit and located around the intersection of the primary and secondary spaces, and a supply air duct located around the bottom of the primary space and communicative with the supply air end of the airflow conduit. The supply air duct can be located in the floor of the primary space and spaced a selected distance away from the outer walls of the primary space.

The apparatus can further comprise inlet and outlet dampers mounted on the building and in airflow communication with the secondary space and the outside; and at least one upper microclimate fan in airflow communication with the inlet and outlet dampers. In such case, the memory can be further encoded with the step of: opening the inlet and outlet dampers and operating the upper microclimate fan to draw cool outside air into the secondary space through the inlet damper and discharging warm air in the secondary space to outside the building through the outlet damper when the temperature outside of the building is cooler than the temperature in the secondary space, and the primary microclimate requires cooling.

### FIGURES

FIG. 1(a) is a schematic side view of a climate control system installed in a building according to a first embodiment.

FIG. 1(b) is a schematic side view of a climate control system installed in a building according to a second embodiment.

FIG. 1(c) is a schematic side view of a portion of the system shown in FIG. 1(b)

FIG. 2 is a schematic plan view of the a supply air duct of the climate control system installed in the building according to the first embodiment.

FIG. 3 is a block diagram of a controller, sensors, and actuators of the climate control system.

FIG. 4 is a flowchart of a climate control strategy recorded on a memory of the controller, the strategy for use with the climate control system.

FIG. 5 is a flowchart of a heating routine of the climate control strategy.

FIG. 6 is a flowchart of a cooling routine of the climate control strategy.

FIG. 7(a) is a schematic plan view of the climate control system installed in a greenhouse according to one embodiment.

FIG. 7(b) is a schematic plan view of the climate control system installed in a greenhouse according to another embodiment.

### DETAILED DESCRIPTION OF EMBODIMENTS

### Apparatus

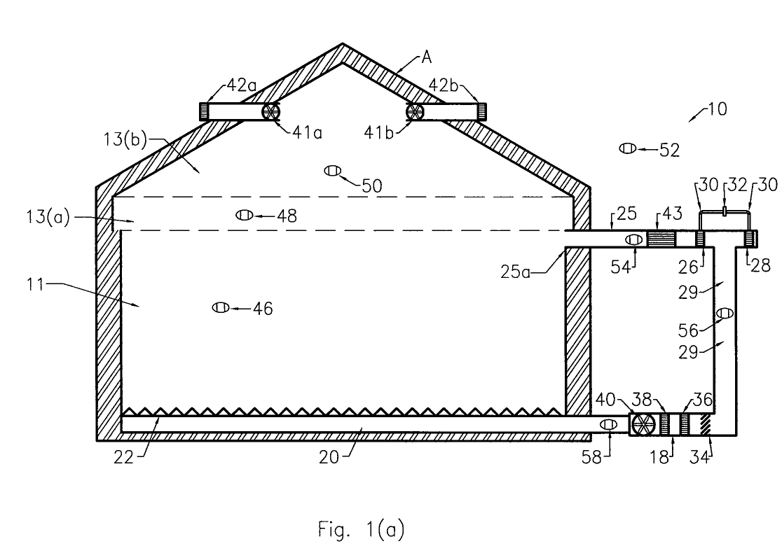

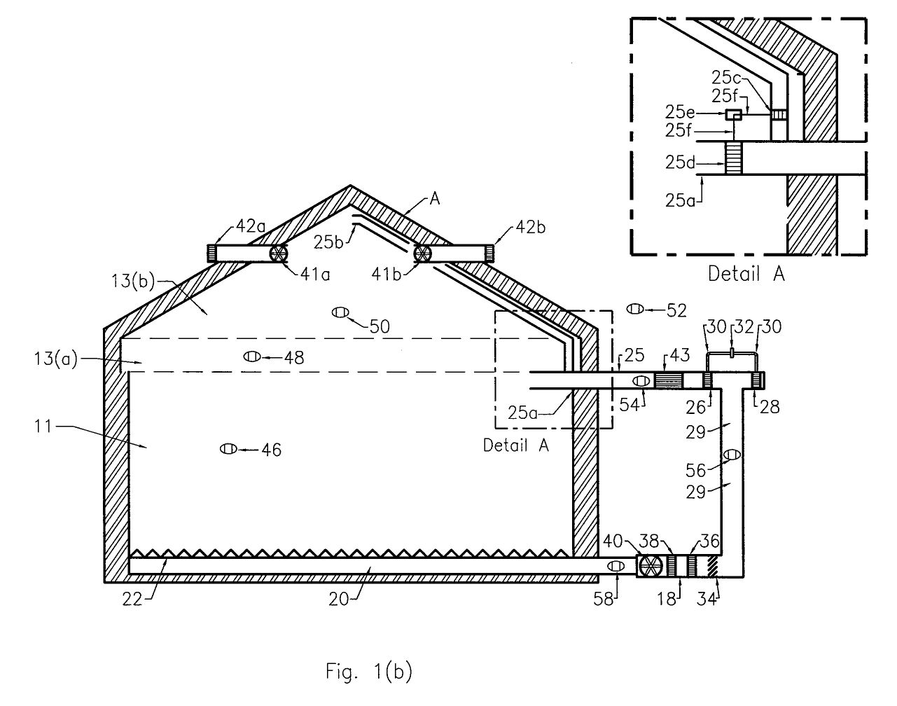

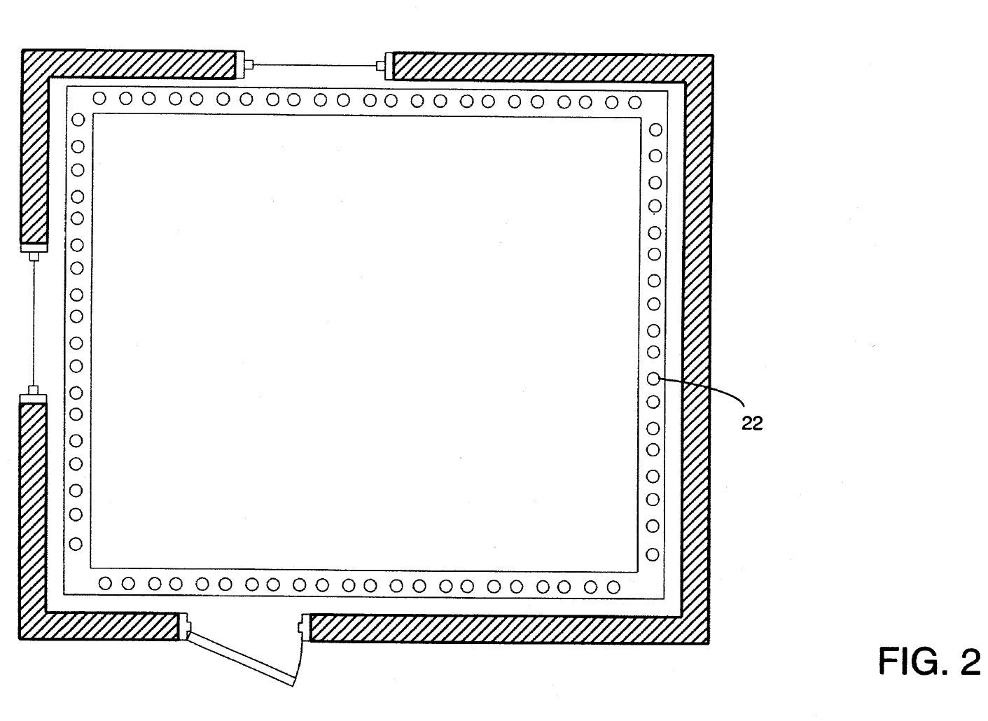

Referring to FIGS. 1(a) and 2 and according to a first embodiment of the invention, a climate control system 10 for a building A is provided which creates and maintains one or more controlled primary microclimates inside one or more spaces 11 in the building A (“primary space(s) 11”) without the use of physical partitions to separate the primary microclimate from other parts 13(a), 13(b) of the building A (“secondary spaces 13(a), 13(b)”) having a climate different than the primary microclimate (“secondary microclimates”). The primary space 11 is the space within the building in which the climate is to be controlled for occupation, e.g. the human-inhabited space within a residence or commercial office building, or the space occupied by plants within a greenhouse, or the storage space for climate sensitive materials and or equipment in a storage facility, or the work space within a manufacturing facility. The embodiment described herein relates to a greenhouse, and as such, the primary space 11 will be space occupied by plants, and the secondary spaces 13(a), 13(b) will the spaces in the greenhouse above the primary space. However, the principles of the climate control system 10 can be readily applied by one skilled in the art to other types of buildings.

As will be described in detail, the climate control system 10 operates to maintain a controlled primary microclimate within the primary space 11, and to direct warmer air to the primary space 11 as needed from secondary spaces 13(a), 13(b) which have been heated by solar gain, thereby reducing the reliance on external heating means such as a furnace and/or boiler to heat the primary space 11. Also, the climate control system 10 operates to discharge heated air from secondary spaces 13(a), 13(b) when cooling of the building A is required, thereby reducing the reliance on external cooling means such as an air conditioner to cool the primary space 11.

The system 10 comprises a number of components which collectively serve to circulate heated or cooled air into the building A. The components include an air circulation unit 18 for circulating air out of and into the building A. The air circulation unit 18 can be located inside (not shown) or outside of the building A. A supply air duct 20 is coupled to the air circulation unit 18 and extends into the building A along the floor thereof. Alternatively but not shown, the supply air duct 20 can be routed through the walls or through other structures in the building as dictated by necessity or convenience. As shown in FIG. 2, the supply air duct extends around the perimeter of the floor in a loop, and is spaced a selected distance from the exterior walls of the building A. Multiple air ports 22 extend upwards on a slight angle away from the exterior walls and/or horizontally from the supply air duct 20 and serve to discharge air into the primary space to create the primary microclimate 11. The configuration of the supply air duct 20 therefore defines the outer perimeter of the primary microclimate 11. While the supply air duct 20 is shown as a rectangular loop in this embodiment, other configurations can be used especially if other shapes of the microclimate are desired. In certain applications, e.g. for crops in a greenhouse, some of the air ducts can even extend across the floor between the perimeter. Optionally, additional air ducts (not shown) can also be used along or within internal walls to diffuse more air into the desired volume.

For structures that are served with multiple air supply and return air ducts (not shown), usage of motorized dampers (not shown) on the supply and return ducting allows for specific spaces to be operated as separate temperature zones within the total climate created by the system 10.

One or more primary microclimate return air ducts 25(a) (one shown) are coupled to the air circulation unit 18 via a common return duct 25 and extends inside the building at a height corresponding to the top of the primary space 11 (and the top of the primary microclimate). The space above the primary space 11 is defined as a secondary space in which is formed a secondary microclimate. In certain buildings such as the building shown in FIG. 1(a) and (b), this secondary space can be further divided into lower and upper secondary spaces 13(a), 13(b) wherein the space directly above the primary microclimate 11 is defined as the lower secondary space 13(a) having a lower secondary microclimate, and the space above the lower secondary space 13(a) and directly adjacent to the ceiling is defined as the upper secondary space 13(b) having an upper secondary microclimate.

The return air duct(s) 25(a) may also extend horizontally into the building A a distance equal to the spacing of the supply air duct 20 from the exterior building of the wall. It has been found that the inset distance of the supply air duct 20 and return air duct(s) 25(a) creates a dead air space from the wall to the vertical edge of the primary space 11; such dead air space is desirable as such space is typically not used by occupants and thus does not need to be climate controlled. A suitable such inset distance is 6″. However, this distance can be adjusted to adjust the perimeter of the primary microclimate. In a heating mode, the dead air space that is created tends to be at a lower temperature than that of the controlled primary microclimate. This reduces the temperature differential on the two sides of the wall, thereby reducing the heat loss through the wall.

According to an alternative embodiment, one or more secondary return air ducts are provided which extend into the upper secondary space 13(b) and collect warm air that will have risen due to convection. Referring to FIGS. 1(b) and 1(c), a secondary return air duct 25(b) extends to the highest point inside the building A, and collects air therefrom for delivery to the common return duct 25. Alternatively and not shown, another return air duct can be positioned to collect air from the lower secondary space 13(a). The secondary return air duct 25(b) is provided with a motorized damper 25(c) coupled by a linkage to damper motor 25(e). Further, the primary microclimate return air duct 25(a) is provided with a motorized damper 25(d) which is also mechanically coupled by a linkage 25(f) to the damper motor 25(e). The secondary return air duct 25(b) is coupled to the primary return air duct 25(a) downstream of the motorized damper 25(d); the dampers 25(c), 25(d) in the primary and secondary return air ducts are used to control the volume of air collected from the primary and/or secondary spaces 11, 13(a), 13(b).

Depending upon the particular design of the building, there may be multiple locations where air in the upper secondary space 13(b) can be gathered, so as to allow for maximum usage of heat energy contained within the secondary micro climate. Should the building design dictate multiple ports (not shown), each of these ports would be supplied with individual control dampers and damper control motors (not shown) so as to control the point in which return air from the secondary micro climate is gathered.

Referring back to FIG. 1(a) and the first embodiment, the air circulation unit 18 is provided with a number of dampers to control the flow of air into and out of the unit 18. A return air damper 26 controls the flow of return air from the common return duct 25; an outside air damper 28 controls the flow of outside air into a mixed air chamber 29 in, and a barometric damper 43 is located in the common return duct 25 and serves to control the air pressure inside the building A. The barometric damper 43 is manually adjustable (typically upon commissioning) so as to open when the internal air pressure increases past a set point; the damper 43 opens enough to let some air out of the return air duct to the outside environment. When pressure diminishes below the set point, the barometric damper 43 closes.

A damper motor 32 is coupled by linkages 30 to the return air damper 26 and the outside air damper 28 and can be operated to open and close these dampers 26, 28 on a proportional basis. The space in the unit ducting after the return air and outside air dampers 26, 28 to immediately prior to air unit 18, is defined as the mixed air chamber 29, wherein air supplied to the primary microclimate can be 100% re circulated air (return air damper 26 opened, outside air damper 28 closed), a mixture of re circulated and fresh air (return and outside air dampers 26, 28 both opened proportionally), and 100% fresh air (return air damper 26 closed, outside air damper 28 opened).

As a result of the variable action of the damper motor 32 which is coupled to the internal damper 26 and the outside air damper 28 with the usage of linkage 30, internal air pressure will increase as the internal damper 26 is closed off and the outside damper 28 is opened; the result is an increase in the internal air pressure which is then relieved with the barometric damper 43 That is, the barometric damper 43 actuates when building air pressure increases as a result of usage of the damper 26 immediately downstream of the barometric damper 43.

Downstream of the dampers 43,26, 28, and after the mixed air chamber 29 and within the unit 18 are inline air filter rack 34, conditioning coils 36, 38 and an air circulation unit fan 40. The unit fan 40 has a variable speed control and has a rating selected to be capable of meeting the desired number of air exchanges per hour within the primary space. The conditioning coils 36, 38 contain a heat transfer fluid such as water or a refrigerant and serves to transfer heat into the air stream circulating in the unit 18, or remove heat from the air stream. The conditioning coils 36, 38 are each coupled to a heat source or a cooling source (both not shown) or to both sources, and can switch between the two sources depending on whether heating or cooling is required. The system 10 can also utilize both hot and cold heat transfer fluids within there respective conditioning coils 36, 38 when controlled dehumidification is required. The heat source can be a hot water boiler or other heating source as is known in the art, and the cooling source can be a heat pump or air conditioner as is known in the art, or even simply a cold water source such as ground water.

The unit fan 40 operates to create an air stream which supplies air into the building A through the supply air duct 20 wherein its supply of air is derived from the mixed air chamber 29. The mixed air chamber 29 receives its air supply directly from the common return duct 25 in combination with outside air that may or may not be required depending on the conditions inside the building A. The control of the air supply is performed by operation of the internal damper 26 and the outside air damper 28. In the second embodiment, initial pre-control or condition of return air is performed via operation of the primary and secondary return air dampers 25(d) and 25(c). At all times positive air flow is maintained within the primary space 11 as the air discharged into the primary space 11 has to return to the return air duct 25 where it will then follow an air stream path back to the air unit 18 directly or it will follow a path directly outside of the building via the barometric damper 43, when the dampers 26 and 28 have been positioned via the damper motor 32 and linkage 32 so as to allow for a supply of outside air. The unit fan 40 can be controlled by a unit fan controller 44 whose operation is controlled by the programming described below.

Near the top of the building's interior in the upper secondary space 13(b) are provided two fans 41(a), 41(b) (“upper microclimate fans”) and each is coupled to respective inlet and outlet dampers 42(a), 42(b) which in combination with the fans 41(a), 41(b) can draw fresh air into the building A through the inlet damper 42(a) with fan 41(a) and discharge air out via the outlet dampers 42b and fan 41b. An upper fan speed controller 45 is provided which controls operation of the fans 41(a), 41(b) and upper dampers 42(a) and 42(b). These fans and dampers should be placed as high as possible within the building A and opposite to each other, and as an alternative the fan and damper placement for the incoming air can be set at a slightly lower level than that of the outgoing fan and damper apparatus.

The climate control system 10 also includes a number of temperature sensors located inside the building A, inside the air circulation unit 18, and outside of the building A. A primary microclimate temperature sensor 46 is located inside the building in the primary space 11 (and inside the primary microclimate). A lower secondary microclimate temperature sensor 48 is located inside the building in the secondary space 13(a) immediately above the intended primary microclimate, i.e. in lower secondary microclimate. An upper secondary microclimate temperature sensor 50 is located near the ceiling of the building in the upper secondary space 13(b).

In the second embodiment, additional sensors (not shown) can be installed in the vicinity of the secondary return air duct 25 (b) to read the air temperature.

An outside air temperature sensor 52 is located outside of the building A. A return air temperature sensor 54 is located in the return air duct 25 upstream of the barometric damper 43. A mixed return air temperature sensor 56 is located in the mixed air chamber 29 just prior to the in line air filters 34 within the air unit 18. A supply air sensor 58 is located in the ducting of the circulation unit 18 immediately downstream of the supply air fan 40 and just prior to entering the supply air duct 20. In the event that control of humidity levels within a structure is desired, additional relative humidity (RH) sensors (not shown) are provided; one RH sensor is placed directly within the controlled space, one directly in the supply air duct adjacent to the air unit fan and a third is placed outside of the building A.

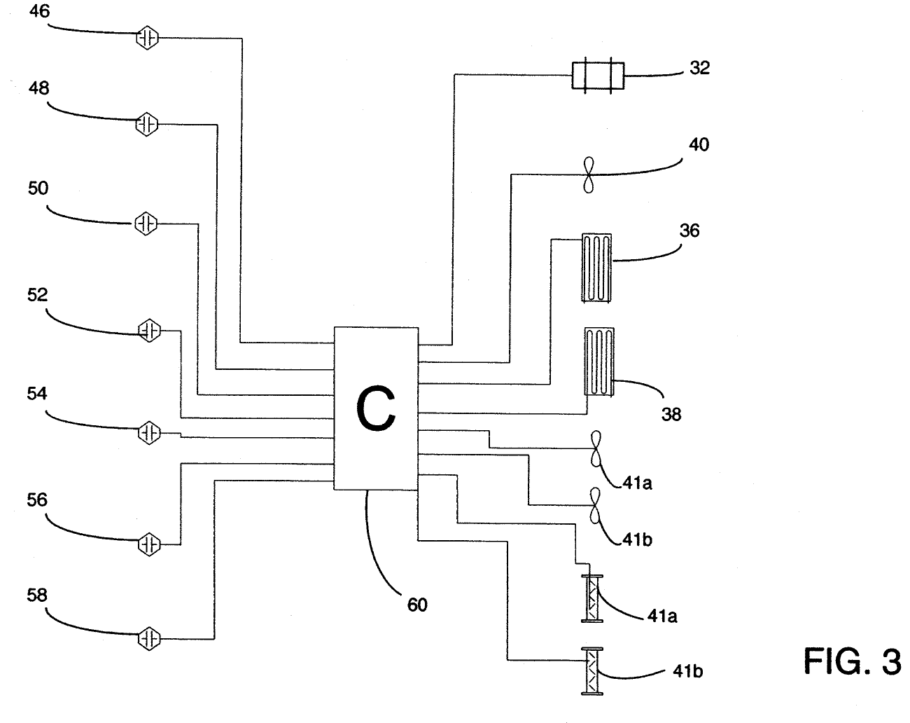

Referring to FIG. 3, the temperature sensors 46, 48, 50, 52, 54, 56, 58 are all communicatively coupled to a system controller 60. The system controller 60 can be a direct digital controller (DDC), a proportional integral derivative controller (PID), a programmable logic controller (PLC), an application specific integrated circuit (ASIC), a general purpose computer, or any type of programmable controller as is known in the art. The processor 60 is also communicatively coupled to the damper motor 32, unit fan 40, upper air fans 41a and 41b, dampers 42a and 42b and heating and cooling sources (not shown) and can activate these components to effect cooling or heating of the primary microclimate 11 inside the building A.

### Climate Control Strategy

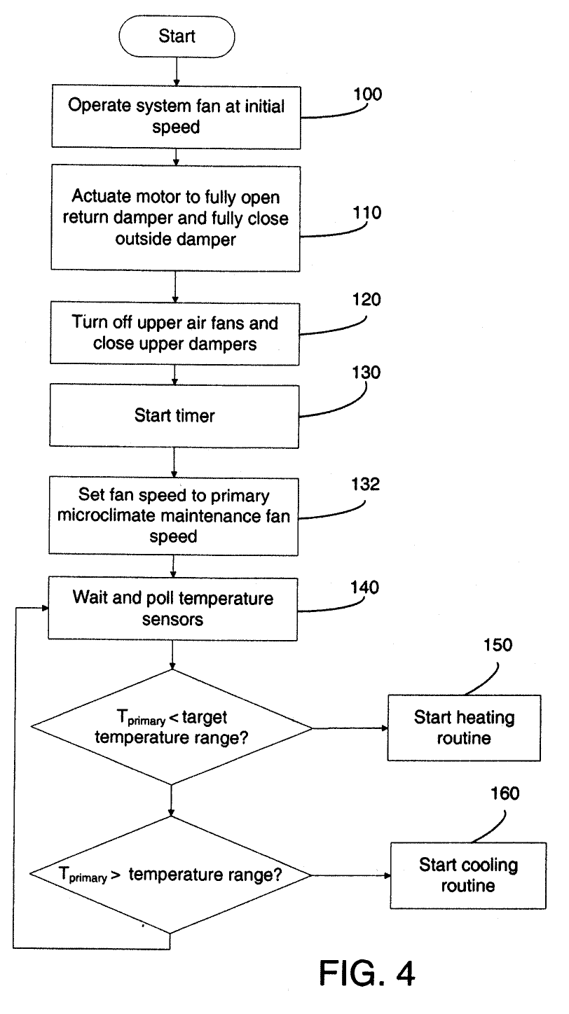

The controller 60 includes a memory having recorded thereon a climate control strategy as shown in the flowcharts of FIGS. 4 to 6. The general objective of the climate control strategy is to maintain the temperature of the primary microclimate in the primary space 11 within a target temperature range.

The principle of the climate control strategy is to operate the fan 40 at a speed which establishes and maintains the primary microclimate within the primary space 11, i.e. maintains a microclimate within the primary space 11 that is distinctly different than the climates in the secondary spaces 13(a), 13(b), and which is different than a space wherein climate is dictated primarily by convection and other natural phenomenon.

When the temperature of the primary microclimate falls outside a target temperature range, the climate control system 10 initiates a heating or a cooling routine to bring the temperature in the primary microclimate back into the target temperature range. During the heating routine, and when the secondary micro climate is warmer than the primary microclimate (e.g. as a result of solar gain), the climate control system 10 will temporarily disrupt the primary microclimate by reducing the speed of fan 40, so as to allow for convection currents to occur, and then gather warm air in the secondary spaces 13(a), 13(b) which is directed into the primary space 11 to heat the primary microclimate. Such heated air will reduce the need to use external heating sources such as a furnace or a boiler, thereby reducing energy expenses considerably.

Conversely, when the primary microclimate needs cooling, the climate control system 10 will operate to remove heated air in the secondary spaces 13(a), (b) from the building A and draw in cooler outside air into the building A, thereby reducing the heating effect that such heated air will have on the primary microclimate. Additionally, the climate control system 10 can reduce the unit fan speed to temporarily disrupt the primary microclimate so that the cool outside air can fall by natural convection phenomena into the primary space 11, thereby actively cooling the primary microclimate. Such cooling strategy will reduce the need to use external cooling sources such as an air conditioner, thereby reducing energy expenses considerably.

Referring to FIG. 4 and upon system start up, the controller 60 executes a standby routine which establishes the primary microclimate in the primary space 11. It is easiest for start up to be done at night, i.e. when there is no thermal influence from solar gain, and when the primary space 11 is already within a target temperature range.

The controller 60 initiates the standby routine by actuating the unit fan 40 to run at an initial speed (“initial speed”, step 100). This first speed is a relatively low speed intended to slowly circulate air through the primary space 11 and to cause warmer air in the secondary spaces 13(a), 13(b) to be directed into the primary space 11 (at start up, natural convection phenomena will, have caused warmer air to rise and result in the upper and lower secondary spaces to be warmer than the primary space). The controller 60 also actuates the damper motor 32 to move the return damper 26 into a fully opened position and the outside damper 28 into a fully closed position (step 110). The controller 60 also turns off the upper air fans 41(a) and 41(b) and closes upper dampers 42(a) and 42(b), if the upper air fans 41(a) and 41(b) and upper dampers 42(a) and 42(b) are not already off and closed (step 120). In the second embodiment, the controller 60 also closes the damper 25(c) in the secondary return air duct 25(b) (not shown).

Shortly after the unit fan 40 is running at the initial speed, the primary microclimate temperature sensor 46 should register a slight rise in temperature in the primary space 11, and the secondary microclimate temperature sensor 48 should register a slight drop in temperature in the lower secondary space 13(a) as warm air from the secondary spaces 13(a), 13(b) is being drawn and discharged into the primary space 11.

The controller 60 then starts a timer (step 130); when the timer elapses, the controller 60 polls the primary and lower secondary microclimate temperature sensors 46, 48 to determine whether at the initial fan speed the temperature in the primary space is rising and the temperature in the lower secondary space is falling. At this slow initial fan speed, the primary microclimate is not expected to have yet formed and thus natural convection phenomena will still dictate the climate in the primary and secondary spaces 11, 13(a), 13(b); therefore, it is expected that the warmer air collected from the secondary spaces 13(a), 13(b) and discharged into the primary space 11 will eventually rise back into the upper and lower secondary spaces 13(a), 13(b), and the temperature in primary space 11 will drop back to around its original level and the temperature in the lower secondary space 13(a) rise back to around its original level. When the temperature of the primary space 11 does not rise, or remains lower than the temperature in lower secondary space 13(a) over a prolonged period of time, the fan speed is incrementally increased until the temperature in the primary space increases 11 and the temperature in the lower secondary space 13(a) drops. This is an indication that the fan 40 is inducing the primary microclimate to form and that natural convection phenomena is being overridden.

The fan speed continues to be incrementally increased until the temperature reading by primary microclimate sensor 46 meets or exceeds the temperature reading of the lower secondary microclimate sensor 48, and has stabilized. The fan speed at which this condition occurs is designated by the controller 60 as the primary microclimate maintenance fan speed. It is noted that even when the temperature in the primary space 11 has stabilized, the temperature in the secondary spaces 13(a), 13(b) may still be dropping, e.g. when it is substantially colder outside the building than inside, natural convection phenomena in the secondary spaces 13(a), 13(b) will cause heat to rise to the ceiling in the building and escape to the outside.

The primary microclimate maintenance fan speed can also be selected to be sufficient to meet a user-specified number of air exchanges per hour specified by the user, e.g. 7-10 air exchanges per hour in a typical greenhouse, or 5-7 air exchanges within a home or building. (exchange rate calculated for primary micro climate space only) The controller 60 calculates the appropriate fan speed using the air flow ratings of the unit fan 40, the volume of the primary space, and the specified number of air exchanges per hour. In a greenhouse application, the unit fan 40 can be designed so that the primary microclimate maintenance fan speed will be about 85% or more of the unit fan's maximum speed.

Should running the unit fan 40 at the any speed not cause the temperature in the primary space 11 to rise and the temperature in the lower secondary space 13(a) to fall, all of the heat in the building may have escaped. In such case, the controller 60 is programmed to proceed directly to the heating routine (this step not shown).

Once the fan 40 is operating at the primary microclimate maintenance fan speed, there should be enough air recirculation within the primary space 11 that the primary microclimate is maintained independently of convection and other natural phenomena; this is best evidenced by the primary microclimate temperature sensor 46 reading a temperature that is the same as or higher than the reading by the lower secondary microclimate temperature sensor 48.

After the primary microclimate has been established, the controller 60 waits and then polls the primary and lower secondary microclimate temperature sensors 46, 48 and determines whether the measured temperatures are within the specified target temperature range (step 140). The controller 60 also calculates the change in primary microclimate temperature since the last time the primary microclimate temperature sensor 46 was polled.

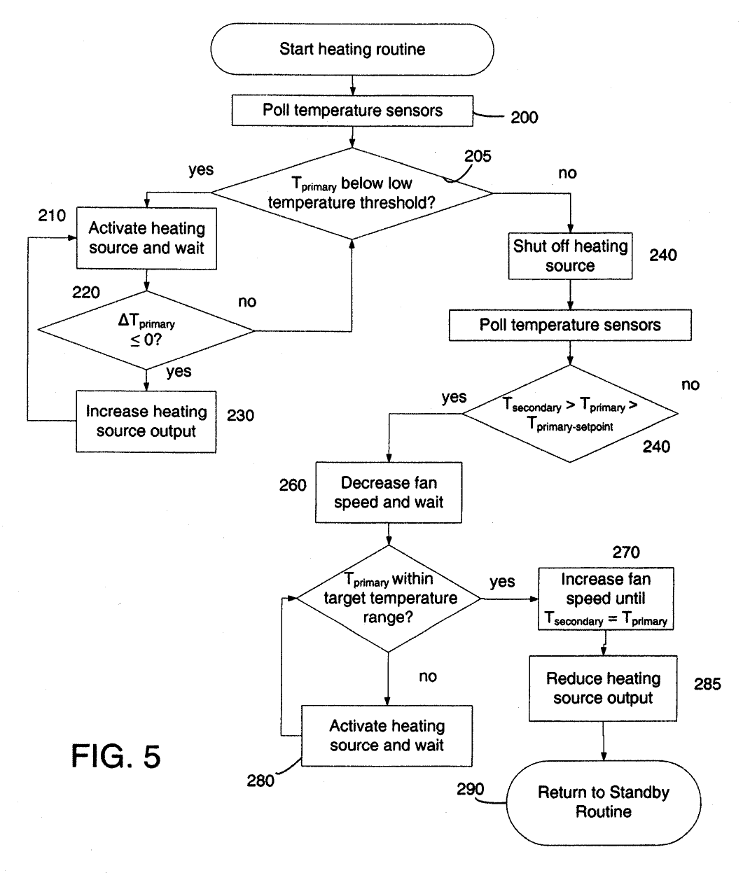

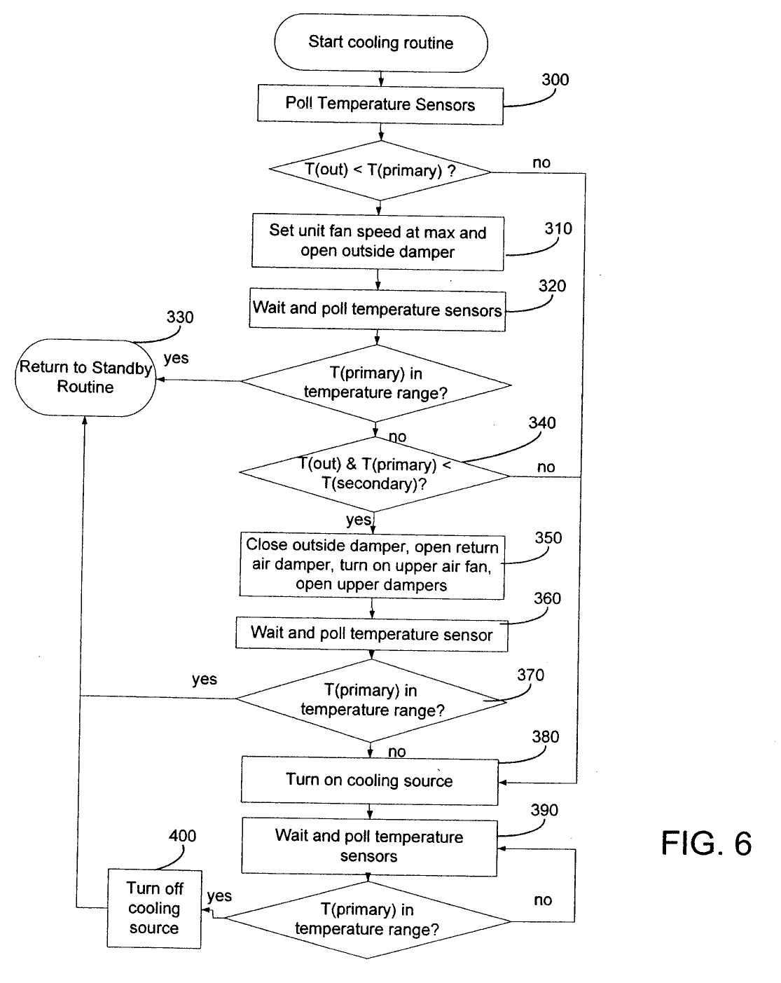

If the primary microclimate temperature is below the target temperature range, the primary microclimate requires heating and the controller 60 exits the standby routine and initiates a heating routine as shown in FIG. 5 (step 150). If the primary microclimate temperature is above the target temperature range or the lower secondary microclimate temperature is rising and has exceeded the primary microclimate temperature by a selected differential, e.g. two degrees Fahrenheit, the primary microclimate requires cooling and the controller 60 initiates a cooling routine as shown in FIG. 6 (step 160). If the primary microclimate temperature is within the target temperature range, then no heating or cooling is required and the controller 60 returns back to the start point of the standby routine.

### Heating

Referring to FIG. 5, the controller 60 initiates a heating routine by first polling temperature sensors 46, 48, 50, 54, 46, 58 (step 200) and determining whether the primary microclimate temperature is below a low temperature threshold (step 205). Such low temperature threshold is user-specified and is a temperature below the lower limit of the target temperature range. This threshold represents a temperature below which is particularly uncomfortable to the occupants within the primary microclimate 11 and thus should be avoided. Thus, when the primary microclimate temperature is below the low temperature threshold, the controller 60 executes an aggressive heating strategy to quickly bring the primary microclimate temperature to within the target temperature range. Particularly, the controller 60 activates a heating source 72 and directs heat generated by the heating source 72 via heating coils 36, 38 and into the primary microclimate 11 in order to quickly heat the primary microclimate 11 (step 210). Optionally, the controller 60 can also increase the unit fan 40 speed to maximum. The heat source 72 can be a boiler, furnace, heat pump or any other heat source as is known in the art suitable for space heating. A refrigerant, water, or other heat transfer fluids can be used as a means to deliver heat from the heat source to the coils 36, 38, wherein the heat is transferred to the air circulated through the system 18.

The controller 60 then waits and polls the temperature sensors again (Step 220). If the primary microclimate temperature remains below the low temperature threshold and is not increasing, then the controller 60 increases the heating source output (step 230). This sequence is repeated until the primary microclimate temperature rises. The controller 60 monitors the rise in primary microclimate temperature and reduces the heat coil output and fan speed when the primary microclimate temperature has reached the low temperature threshold (step not shown).

Optionally but not shown, the controller 60 can gradually reduce the heat coil output and/or fan speed as the rising primary microclimate temperature approaches the low temperature threshold and/or the lower limit of the target temperature range. This technique should avoid the primary microclimate temperature from overshooting the target temperature range.

Once the primary microclimate temperature is at or above the low temperature threshold but remains outside the target temperature range, then a gentler and more energy efficient heating strategy is deployed to bring the primary microclimate temperature into the target temperature range. Such strategy involves stopping the heating coil output (step 240) and relying entirely on the fan 40 to control the temperature in the primary microclimate. The controller 60 polls the primary micro climate temperature sensor 46 and the lower secondary micro climate temperature sensor 48 (step 250). Should the measured temperature in the lower secondary micro climate be higher than that of the primary micro climate, and the temperature of the lower secondary micro climate is in excess of the temperature set point target of the primary micro climate, then the opportunity arises to recover heat from the lower secondary micro climate to heat the primary microclimate. This condition typically exists as a result of solar gain which heats up the air in the upper and lower secondary spaces 13(a), 13(b) after the sun rises; as the standby routine established the primary microclimate with the unit fan 40 operating at the primary microclimate maintenance fan speed at night, the solar gain heat in the secondary spaces 13(a), 13(b) remain to be tapped for heating the primary microclimate. Although this phenomena is particularly acute for greenhouses, solar gain will also provide significantly heat to secondary spaces in warehouses and human-occupied buildings.

To access the heated secondary microclimate air, the controller 60 instructs the unit fan 40 to slowly reduce in speed until the temperature measured by the return air sensor 54 starts to increase (step 260). This indicates that the primary microclimate has been disrupted, that convection currents are present and that heat present in the lower secondary micro climate is being drawn into the return air stream of the system 10; consequently, the supply air temperature measured by sensor 58 should start to increase and thus increase the temperature of the primary space 11. By reducing the fan speed to below the primary microclimate maintenance fan speed, the system 10 draws heat out of the lower secondary space 13(a) and directs this heat into the primary space 11.

Once the polling of the temperature sensors shows the temperature starting to rise within the primary space 11, and as the lower secondary micro climate temperature starts to reduce, then the fan speed is increased with the purpose of reforming the primary microclimate in the primary space 11 and containing the heat within the primary microclimate. The fan 40 is run at a speed that allows for the temperature sensor 48 within the lower secondary micro climate to be the same as or less than the temperature recorded by the primary micro climate sensor 46. In order for this efficient condition to exist, the fan speed is slowly increased until similar temperature readings are detected between the primary micro climate sensor 46 and the return air sensor 54 within the return air duct (step 270). Once the readings of sensors 46 and 54 are substantially the same, the temperatures recorded within the secondary space should slowly reduce over time, thus showing clearly that the heat contained within the primary space is been contained within it. The fan speed is controlled so that the primary microclimate temperature is brought into and held within the target temperature range.

Should the primary microclimate temperature remain below the target temperature range after a prolonged period at the reduced fan speed, then likely there is insufficient heat in the secondary spaces 13(a), 13(b) to maintain the primary microclimate within the target temperature range. In this case, the controller 60 activates the heating source and directs heat into primary space 11 (step 280), and increase the fan speed 40 to reestablish the primary micro climate and contain the heat in the primary space 11.

Once the primary microclimate temperature has risen to within the target temperature range, the controller 60 reduces the heating coil output and sets a fan speed that is determined by keeping the relationship between the primary temperature sensor 48 and the return sensor 54 as close to each other as possible and at the lowest fan speed to conserve energy (step 285). This is maintained until the primary microclimate temperature stops increasing, and then the controller 60 exits the heating routing and returns to the standby routine (step 290).

As it can be seen from the steps carried out in FIG. 5, all or a significant part of the heat used to heat the primary microclimate to within the target temperature range comes from the existing heat within the primary space 11 and from heat contained in the secondary space(s) 13(a), 13(b). The only energy needed to recover a large portion of the heat supplied to the primary microclimate is the electricity to operate the unit fan 40. The only time heating by the heat source 72 is required is when the primary microclimate temperature falls below the low temperature threshold and an aggressive heating strategy is required, or when there is insufficient heat in the secondary space(s) to solely heat the primary space. As a result, there is a significant energy savings in heating the primary microclimate according the above method when compared to heating by heat source 72 alone.

It is noted that the as the fan speed increases, and as the return air temperature measured by sensor 54 becomes closer to that of the temperature of the primary space measured by sensor 46, a state of “recycled heating” exists; during this state, the heat loss of the building is reduced, as the heat that would normally be convected to the roof or ceiling area is significantly reduced. This is demonstrated by the fact that the temperature of the secondary space 13(a), 13 (b) which is directly above the primary space 11 tends to be lower than the temperature of the primary space 11.

In the second embodiment (not shown), the controller executes the additional following steps:

When the temperature measured by upper secondary microclimate sensor 50 is greater than a user-specified differential (e.g. 2 degrees Celsius) above the temperature measured by the lower secondary microclimate sensor 48, which is higher than the temperature measured by the return temperature sensor 54, and the primary microclimate is requiring heat, then the controller 60 controls the damper motor 25(e) to partially close the primary return damper 25(d) and to partially open the secondary return damper 25(c). The purpose of this action is to draw stratified heat from the upper secondary space 13(b). The controller 60 controls the position of the dampers 25(c), 25(d) based on measurements collected by the air temperature sensor 54. As secondary return damper 25(c) is partially opened and primary return damper 25d is partially closed, the temperature in the primary microclimate as measured by the air sensor 54 should rise, as the warm air present in the upper secondary space 13(b) will be returning via the air duct 25(b).

When the upper secondary microclimate temperature drops to within the user-specified differential of the lower secondary microclimate temperature, the controller 60 controls the damper motor 25(e) to close the return damper 25(b) and fully open the return damper 25(d).

These steps are performed to keep the majority of the total system air flow confined within the primary space 11. As a portion of the total air flow is returning to the air unit 18 via the secondary return duct 25(b), some of the air discharged into the primary space 11 will be “pushed” into the lower secondary space 13(a) immediately above the primary space 11. While the temperature of the primary space 11 is less than that of the lower secondary space 13(a), the air pushed upwards from the primary space 11 will tend to allow the further stratification and concentration of the heat directly above, or near the top of the structure where the secondary return duct is positioned. The heat contained within the upper secondary space 13(b) is returned to the air unit 18 along with air from the primary space 11. The process continues until available heat in the upper secondary space 13(b) is no longer causing the mixed air return temperature to be greater than that of the primary space 11, and the upper secondary microclimate temperature is within the user-specified temperature differential of the lower secondary microclimate and/or the temperature of lower secondary microclimate is equal to or less than that of the primary micro climate.

### Cooling

When the primary microclimate temperature is above the target temperature range, a cooling routine shown in FIG. 6 is executed.

Referring to FIG. 6, the controller 50 polls the primary, lower and upper secondary microclimate temperature sensors 46, 48, 50 as well as the outside temperature sensor 52 (step 300).

When the measured outside temperature 52 is less than the primary microclimate temperature 46, then the controller 60 opens the outside air damper 28, closes the return air damper 26 and the unit fan 40 is set to maximum speed (step 310). The controller 60 then waits and then polls the temperature sensors 46, 48, 50, 52 (step 320); if the primary microclimate temperature falls within the target temperature range, then the controller 60 returns the fan speed back to the primary microclimate maintenance speed and exits the cooling routine and returns to the standby routine (step 330).

If the primary microclimate temperature remains above the target temperature range, and the upper and lower secondary microclimate temperature are higher than the primary microclimate and outside temperatures (step 340), then heat stratification exists within the building A and heat therein can be attempted to be discharged from the building A without the usage of any air conditioning cooling equipment. The controller 60 closes outside damper 28 and opens return air damper 26. The controller 60 also turns on the upper air fans 41a, 41b and opens the upper inlet and outlet dampers 42a and 42b (step 350), then waits (step 360). Cooler outside air is drawn into the upper secondary space through the inlet dampers 42a with the assistance of upper air fan 41a; also, warm air in the upper secondary space as well as rising warm air from the lower secondary space is discharged through the outlet dampers 42b with the aid of the upper fan 41b.

The controller 60 then waits and polls the temperature sensors 46, 48, 50, 52 to confirm that the temperature in the primary space is dropping. It is theorized that the primary space should cool, as the cooler outside air is injected directly into the upper area of the building structure via the upper damper 42a and upper fan 41a and the same volume of hotter air is removed with fan 42b via damper 42b. This has the effect of reducing the heat in the secondary spaces, and thus the heating influence on the primary microclimate 11 by the secondary microclimates should be reduced.

Should the temperature of the primary space not drop sufficiently, the controller 60 can reduce the fan 40 speed to disrupt the primary microclimate in the primary space, so that natural convection can occur, and allow the cooler outside air to drop down into the lower secondary space, thereby further cooling the primary space (step not shown). Once the primary microclimate temperature has fallen to within the target temperature range, the controller 60 instructs the fan 40 to return back to the primary microclimate maintenance fan speed.

If the primary microclimate temperature has fallen to within the target temperature range (step 370), then the controller 60 exits the cooling routine and enters the standby routine (step 330) while maintaining the primary microclimate maintenance fan speed.

If the measured primary microclimate temperature is still above the target temperature range and the outside temperature is less than the mixed air return temperature, then the controller 60 attempts to cool the primary microclimate further by opening the outside damper 28 and closing the return air damper 26, thereby drawing in additional colder air from the outside (not shown).

The controller 60 waits again, then polls the primary microclimate temperature sensor 46; if the primary microclimate temperature still remains above the target temperature range (step 370), the controller activates a cooling source 73 (step 380). The cooling source can be a heat pump, air conditioner, or another cooling source as is known in the art for cooling a space. A refrigerant, water, or other cooled heat transfer fluid is circulated through one or both of the conditioning coils 36, 38 to cool the air circulating through the system 18. The controller 60 continues to operate the cooling source 73 until the temperature in the primary space reaches the target temperature range (step 390). The cooling source 73 is then deactivated (step 400), and the controller 60 exits the cooling routine and enters the standby routine (step 330).

If the measured outside temperature is greater than the temperature in the upper secondary space or the mixed air return temperature, then the controller 60 proceeds directly to activate the cooling source 73. Also, the outside damper 28 is closed and inside damper 26 is opened, as well as all upper fans and dampers 41, 42 are. fully activated.

As discussed above, prior to usage of cooling the primary space with the cooling coils within the air unit, a poll of all temperature sensors is taken, and if it is found that the lower secondary microclimate temperature is less than the primary microclimate temperature, the controller 60 can then reduce the unit fan 40 speed so as to allow for the primary microclimate in the primary space to diminish. By reducing the fan speed, and allowing the previously established primary microclimate to diminish, natural convective currents should subsequently take over and will thus allow the air that is cooler within the lower secondary microclimate to drop down into and cool the primary space. The warm air that was present within the primary microclimate should rapidly rise up into the secondary microclimate. This period of utilizing convective currents in conjunction with the upper fans and dampers for cooling the facility ceases when the primary microclimate temperature rises above its desired set point and when the temperature of the lower secondary microclimate directly above it is higher in temperature than the primary microclimate, which thus means that heat stratification exists again. At this point the controller 60 would start increasing the unit fan 40 speed again so as to re-establish the primary microclimate and would then allow for usage of the cooling coils 34, 36 within the air unit 18 to control the temperature within the primary space.

### Climate Control System in Greenhouse

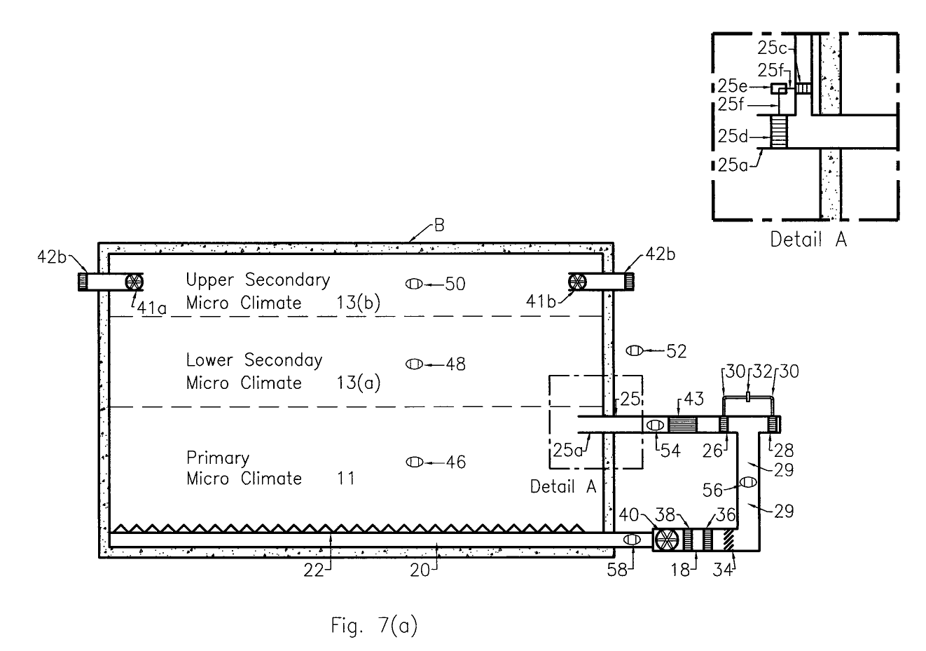

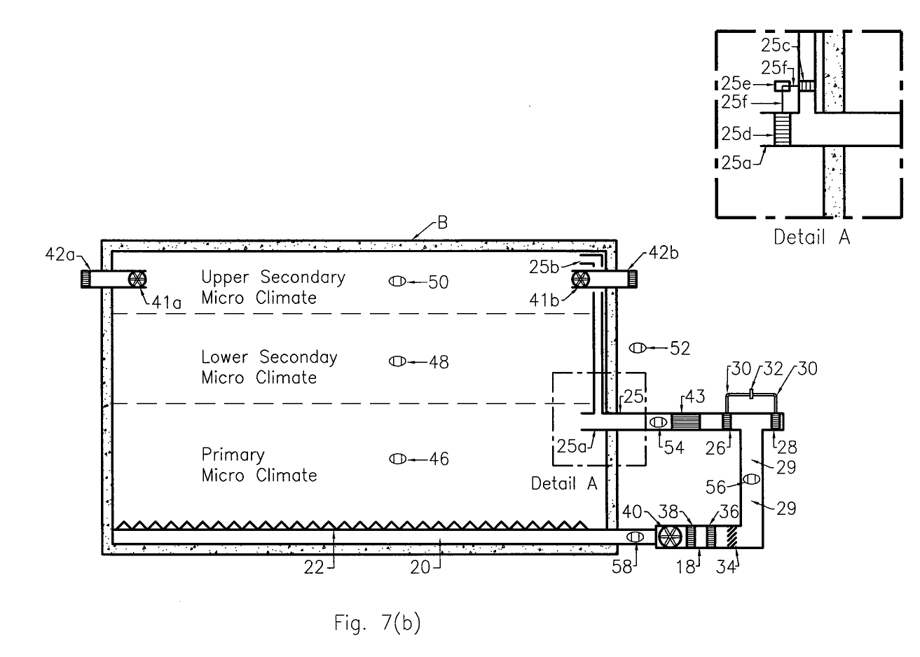

One particularly advantageous application of the climate control system 10 is in a greenhouse. Referring to FIGS. 7(a) and (b), the climate control system 10 is installed in a greenhouse B to maintain a microclimate favorable for crop growth therein.

Within the greenhouse a number of conditions are important for the successful growth of crops, e.g. fruit. These conditions include: heat, ventilation, and humidity. The strategy for controlling heat has been described above. The system 10 can also be operated to control the humidity within the greenhouse or any other building. According to an alternative embodiment, a humidity sensor is installed inside the primary microclimate, and conditioning coil 36 is operated to cool the air passing therethrough; the cooling results in condensation and water is removed from the air. The second conditioning coil 38 is operated to heat the air passing therethrough, thereby returning the heat to the air that was extracted when the air was being dehumidified to user defined targets. The end result of the two steps is that the resulting supply air is warmer and of lower humidity, plus the benefit of recovered water. Dehumidifying continues until the humidity sensor detects that the air is within the proper humidity range and heating continues until temperatures are within the target ranges. It may be necessary to provide some additional reheating to replace heat that was removed during the dehumidifying process in order to maintain the desired temperature levels.

The climate control system 10 is effective to shape and maintain a temperature- and humidity controlled primary microclimate within the greenhouse B. The primary microclimate is defined as the space within which the crops occupy, and has an upper ceiling above the top of the crops.

### Example

The climate control system 10 was installed in a greenhouse and tested. The greenhouse was constructed with single glass pane walls with twenty gutter connected peaks. The total interior area of the greenhouse was 56,350 sq. ft. The greenhouse was originally fitted with boilers for providing space heating; the total rated output of these boilers under normal operation was 4,038,568 BTU/hour. The boilers were rated at 80.0% efficiency, and thus the energy input capacity for the boilers under normal operation was 5,016,855 BTU/hour.

Over an eight hour period, the total energy used to operate the boilers would have been 4,204,244 BTU, or 1231.297 kW, based on heat loss calculations to maintain the required greenhouse temperatures and to maintain the current design load conditions of inside 51.4° F. vs and outside temperature of 44° F. using conventional climate control techniques.

The greenhouse was fitted with four climate control systems according to the described embodiment of the invention, each having a 10 HP fan, and three conditioning coil compressors (one 10 HP and two 7.5 HP compressors), for a total of four 10 HP fans, four 10 HP compressors, and eight 7.5 HP compressors. The compressors were used as heat pumps that produce heat and transfer the heat to the primary microclimate via the conditioning coils. The four systems were operated and tested over an eight hour period from midnight to 8:00 AM in January. Over this eight hour period, the four 10 HP compressors operated for a total of 5.3 hours, and the eight 7.5 HP compressors operated for a combined total of 14 hours, consuming 47.47 KW and 91.7 KW respectively. The total energy consumption by the conditioning coil compressors was thus 137.17 KW. During this time, the boilers were off.

The four 10 HP fans operated continuously over the eight hour period, and consumed 284.07 KW overall. The total energy consumption of the systems to maintain the greenhouse at the temperature set point was 423.24 KW. This figure represents an over 65.63% reduction in energy cost when compared to heating the greenhouse solely by conventional boilers. The energy savings increase to over 80% when compared to typical greenhouse operating parameters wherein heating and dehumidification is required and the systems normally would be inputting heat while allowing for active roof venting (which lets out warm moist air and cooler air in).

While a particular embodiment of the present invention has been described in the foregoing, it is to be understood that other embodiments are possible within the scope of the invention and are intended to be included herein. It will be clear to any person skilled in the art, that modifications of and adjustments to this invention, not shown, are possible without departing from the spirit of the invention as demonstrated through the exemplary embodiment. The invention is therefore to be considered limited solely by the scope of the appended claims.

1. A method of controlling the climate in a primary space within a building having a secondary space open to and above the primary space, the method comprising:
when the temperature in the secondary space is higher than the temperature in the primary space, drawing air from the secondary space at around the intersection of the primary and secondary spaces and discharging the drawn air into the primary space at around the bottom thereof at a rate selected to cause the temperature in the primary space to rise and the temperature in the secondary space to fall; and
circulating air within the primary space at a primary microclimate maintenance rate selected to cause the temperature in the primary space to stabilize at or above the temperature in the secondary space, thereby establishing a primary microclimate in the primary space that is resistant to convection phenomena in the primary and secondary spaces.

2. The method as claimed in claim 1 further comprising selecting the primary microclimate maintenance rate by drawing air from the secondary space and discharging the drawn air into the primary space at an initial rate and incrementally increasing this rate until the temperature in the primary space rises and the temperature in the secondary space falls, and the temperature in the primary space stabilizes at or above the temperature in the secondary space.

3. The method as claimed in claim 2 wherein the air is discharged around the perimeter of an area on the floor of the primary space.

4. The method as claimed in claim 3 wherein the primary microclimate is established during a period of no solar gain.

5. The method as claimed in claim 4 further comprising:
during a period of solar gain when the temperature of the secondary space has risen above the temperature in the established primary microclimate and when the primary microclimate requires heating, reducing the air exchange rate such that the primary microclimate is disrupted and air heated by solar gain is drawn from the secondary space and discharged into the primary space; and
when the temperature of the primary space has risen to within a target temperature range or after an elapsed period of time, increasing the air exchange rate to the primary microclimate maintenance rate thereby re-establishing the primary microclimate within the primary space.

6. The method as claimed in claim 5 wherein when after the elapsed period of time after the primary microclimate has been disrupted and the temperature in the primary space has not risen to the target temperature range, directing heat from a heating source into the primary space and increasing the air exchange rate to the primary microclimate maintenance rate thereby re-establishing the primary microclimate within the primary space.

7. The method as claimed in claim 4 wherein when the temperature of the primary microclimate is below a low temperature threshold, directing heat from a heating source into the primary space until the temperature in the primary microclimate has risen above the low temperature threshold.

8. The method as claimed in claim 4 further comprising:
when the temperature outside of the building is cooler than the temperature in the secondary space, and the primary microclimate requires cooling, drawing cool outside air into the secondary space and discharging warm air in the secondary space to outside the building.

9. The method as claimed in claim 8 further comprising:
when the outside air is cooler than the air in the primary microclimate and the primary microclimate requires cooling, reducing the air exchange rate such that the primary microclimate is disrupted and cool outside air falls from the secondary space into the primary space; and
when the temperature of the primary space has fallen to within a target temperature range or after an elapsed period of time, increasing the air exchange rate to the primary microclimate maintenance rate thereby re-establishing the primary microclimate within the primary space.

10. The method as claimed in claim 5 wherein when after the elapsed period of time after the primary microclimate has been disrupted and the temperature in the primary space has not fallen to the target temperature range, directing cooled air from a cooling source into the primary space and increasing the air exchange rate to the primary microclimate maintenance rate thereby re-establishing the primary microclimate within the primary space.

11. An apparatus for controlling the climate in a primary space of a building having a secondary space above and open to the primary space, the apparatus comprising:
(a) an air circulation unit having a unit fan and an airflow conduit in airflow communication with the fan, and having a return air end in airflow communication with the secondary space at the intersection of the primary and secondary spaces and a supply air end in airflow communication with the primary space at around the bottom thereof;
(b) a primary microclimate temperature sensor in the primary space;
(c) a secondary microclimate temperature sensor in the secondary space; and
(d) a controller communicative with the air circulation unit and the primary and secondary microclimate temperature sensors and having a memory encoded with steps and instructions for execution by the controller to carry out a method comprising:
when the temperature measured by the secondary microclimate temperature sensor is higher than the temperature measured by the primary microclimate temperature sensor, operating the fan to draw air from the secondary space and discharging the drawn air into the primary space at a rate selected to cause the temperature in the primary space to rise and the temperature in the secondary space to fall; and
operating the fan to circulate air within the primary space at a primary microclimate maintenance rate selected to cause the temperature in the primary space to stabilize at or above the temperature in the secondary space, thereby establishing a primary microclimate in the primary space that is resistant to convection phenomena in the primary and secondary spaces.

12. The apparatus of claim 11 wherein the memory is further encoded to select the primary microclimate maintenance rate by operating the fan to draw air from the secondary space and discharging the drawn air into the primary space at an initial rate and incrementally increasing the rate until the temperature in the primary space rises and the temperature in the secondary space falls, and the temperature in the primary space stabilizes at or above the temperature in the secondary space.

13. The apparatus of claim 12 wherein the apparatus further includes a supply air duct located around the perimeter of the floor

14. The apparatus of claim 13 wherein the supply air duct is spaced a selected distance away from the outer walls of the primary space.

15. The apparatus as claimed in claim 14 wherein the memory is further encoded with the steps of:
during a period of solar gain when the temperature measured by the secondary microclimate temperature sensor has risen above the temperature measured by the primary microclimate temperature sensor and when the primary microclimate requires heating, reducing the fan speed such that the primary microclimate is disrupted and air heated by solar gain is drawn from the secondary space and discharged into the primary space; and
when the temperature measured by the primary microclimate temperature sensor has risen to within a target temperature range or after an elapsed period of time, increasing the fan speed to the primary microclimate maintenance rate thereby re-establishing the primary microclimate within the primary space.

16. The apparatus as claimed in claim 14 wherein the controller is communicative with a heating source and the memory is further encoded with the step of:
when after the elapsed period of time after the primary microclimate has been disrupted and the temperature in the primary space has not risen to the target temperature range, directing heat from a heating source into the primary space and increasing the fan speed to the primary microclimate maintenance rate thereby re-establishing the primary microclimate within the primary space.

17. The apparatus as claimed in claim 11 further comprising
inlet and outlet dampers mounted on the building and in airflow communication with the secondary space and the outside;
at least one upper microclimate fan in airflow communication with the inlet and outlet dampers; and
the memory further encoded with the step of: opening the inlet and outlet dampers and operating the upper microclimate fan to draw cool outside air into the secondary space through the inlet damper and discharging warm air in the secondary space to outside the building through the outlet damper when the temperature outside of the building is cooler than the temperature in the secondary space, and the primary microclimate requires cooling.

18. The apparatus as claimed in claim 17 wherein the memory is further encoded with the steps of:
reducing the speed of the unit fan such that the primary microclimate is disrupted and cool outside air falls from the secondary space into the primary space when the outside air is cooler than the air in the primary microclimate and the primary microclimate requires cooling; and
increasing the speed of the unit fan to the primary microclimate maintenance rate thereby re-establishing the primary microclimate within the primary space when the temperature of the primary space has fallen to within a target temperature range or after an elapsed period of time.

19. The apparatus as claimed in claim 18 wherein the controller is communicative with a cooling source, and the memory is further encoded with the step of directing cooled air from the cooling source into the primary space and increasing the unit fan speed to the primary microclimate maintenance rate thereby re-establishing the primary microclimate within the primary space when the elapsed period of time after the primary microclimate has been disrupted the temperature in the primary space has not fallen to the target temperature range.
